(19) United States
(12) Patent Application Publication
(10) Pub. No.: US 2020/0287905 A1
(43) Pub. Date: Sep. 10, 2020

(54) DEVICES, SYSTEMS, AND METHODS FOR CONTROLLING USER RIGHTS IN ELECTRICAL APPLIANCES

(71) Applicant: Angaza Design, Inc., Redwood City, CA (US)

(72) Inventors: Joshua MILBURN, APO, AP (US); Bryan SILVERTHORN, San Carlos, CA (US); Eric THORNE, San Francisco, CA (US); Austin JACOBSON, Berkeley, CA (US); Justin BELTRAN, Fremont, CA (US)

(73) Assignee: Angaza Design, Inc., Redwood City, CA (US)

(21) Appl. No.: 16/811,877

(22) Filed: Mar. 6, 2020

Related U.S. Application Data
(60) Provisional application No. 62/814,654, filed on Mar. 6, 2019.

(51) Int. Cl. H04L 29/06; G06Q 20/22; G06Q 20/08; G06Q 20/14; G06Q 20/38; G06Q 20/10; G06Q 50/06

(52) U.S. Cl. CPC H04L 63/102; H04L 63/083; G06Q 20/29; G06Q 20/085; G06Q 2220/00; G06Q 20/3829; G06Q 20/108; G06Q 50/06; G06Q 20/145

(57) ABSTRACT

A system for controlling electrical devices based on usage credits associated with a plurality of electrical devices includes a first controller of a first electrical device, the first controller is configured to receive a first message and a second message generated from an external network, the first message includes a plurality of authentication codes, the second message includes usage credits associated with a second electrical device, the first controller is further configured to extract a first authentication code of the first message, determine whether the first authentication code is valid, transmit a second authentication code of the first message for requesting a first communication link between the first electrical device and the second electrical device; and a second controller of the second electrical device, the second controller is configured to determine whether to establish the first communication link based on the second authentication code of the first message.

### CROSS-REFERENCE TO RELATED APPLICATIONS

This application claims the benefit of U.S. Provisional Application No. 62/814,654, filed Mar. 6, 2019, the entire contents of which are incorporated herein by reference.

### FIELD OF THE DISCLOSURE

This invention relates to devices, systems, and methods for administering and enforcing user rights in electrical appliances. In particular, a master device can control whether one or more slave devices are enabled based on whether a remote server authorized a user to use the devices together.

### BACKGROUND OF THE DISCLOSURE

Pay-as-you-go (PAYG) technology allows consumers to purchase goods that would otherwise be prohibitively expensive for some consumers to pay for up front. Rather than requiring full payment for a device at the time of purchase, PAYG technology allows for a user to pay for an electronic device and/or power for the device on an incremental basis as they use the device.

Standalone PAYG devices, such as lighting devices and televisions, exist today, as do larger, componentized PAYG systems, such as solar home systems. Such PAYG devices typically implement a power switch to cut off power to the device when the end user is not current in their payments. In some larger PAYG installations, such as a solar home system with an integrated battery, a seller may bundle together with the system smaller electronic accessories, such as lamps and televisions. Often, such accessories do not include their own integrated PAYG enforcement mechanism. Instead, bundled PAYG systems may include only a single power switch, located upstream at the battery, that enables or disables all power outlets in the system based on whether the end user is current in their payments. Where PAYG bundles include accessory devices that do not include an independent integrated PAYG enforcement mechanism, the end user may circumvent the PAYG arrangement by connecting the accessories to an auxiliary power source, such as a 12V battery. Therefore, in bundled systems, it is necessary for each device to have its own integrated PAYG enforcement mechanism.

Problems arise, however, where each device in a system requires an independent PAYG enforcement mechanism. When an end-user buys multiple PAYG products under a single payment plan, each metered device must have its PAYG credit modified independently after a payment. Often, this occurs by the end user entering a unique keycode into each metered product, with the number of keycodes increasing as the number of products increases. In addition to the inconvenience of having to enter a separate keycode into each device, timing issues arise where an end user must enable each device sequentially, at slightly different times. That is, where an end user would prefer to enable the entire system simultaneously—for example, on a daily or weekly basis—each device in the system may nonetheless shut off a few minutes apart due to having been enabled at slightly different times. Further, where an end user must enter a unique code into each metered product, every product must include user interface hardware, increasing cost.

### SUMMARY OF THE DISCLOSURE

There exists a need for a system for controlling bundled PAYG devices in which the end user activates and uses the account by interacting with only one device and does not permit end users to bypass the PAYG arrangement by connecting accessory devices to an auxiliary power source. This need may be addressed by the devices, systems, and methods disclosed herein for managing PAYG credits and enforcement for a set of PAYG devices. The system includes one or more ‘slave’ devices, each slave device having an integrated PAYG enforcement mechanism, such as a power switch and/or a controller. The system also includes a single ‘master’ device, which may be a PAYG device with a PAYG enforcement mechanism or other electronic device, such as a smartphone. The system also includes a back-end server that is authorized to control the PAYG devices. The back-end server manages whether the end user may enable the master device or update a PAYG status of the master device. The back-end server also manages whether the end user may enable one or more slave devices or update a PAYG status of the one or more slave devices based on communication with the master device.

When an event occurs that affects the operating status of one or more devices—for example, when a user makes a payment via a cell phone application or directly to a PAYG distributor—a back-end server may generate a keycode which contains encoded information that may be retrieved by the master device. The keycode allows the master device to authenticate whether a link between the master device and the back-end server is authorized and allows the one or more slave devices to authenticate whether the back-end server authorized the master device to link with the one or more slave devices associated with the user's account. For example, the keycode may contain a master device authentication code and a slave device authentication code. The master device may retrieve the master authentication code from the keycode to authenticate communication from the server. If the master device determines the master authentication code is valid, the master device continues parsing the message to retrieve information regarding usage information of the master device and/or to retrieve the slave device authentication code. The master device may transmit the retrieved slave device authentication code to the slave device as part of a request to establish a communication link between the master device and the slave device. If the slave device determines based on the slave device authentication code that the server authorized the master device to link with the slave device, then the slave device may accept the request and establish the communication link between the master device and the slave device. In some embodiments, the back-end server, not the user, designates which devices may be linked and provides authentication information associated with the one or more designated links in the keycode that is received by the master device.

In some embodiments, the keycode may encode information allocating a certain amount of usage credits to one particular slave device associated with the bundle. Alternatively, the keycode may encode information authorizing the entire bundle of devices to be enabled for a period of time. If a master device includes a direct communications link with the back-end server, the server may transmit information regarding the payment directly to the master. Alternatively, to update the system based on the payment, the user may input a single keycode directly into the master device. A microprocessor within the master device may decode the information contained in the keycode and establish a communications link with one or more of the slave devices. The master device may transmit, to one or more of the slave devices, information about the payment and/or usage credits. Based on the information, the operating status of one or more of the slave devices may be updated to reflect the user's most recent usage credit information, such as by enabling the device for an amount of time corresponding to the user's payment.

The PAYG devices may also store usage and maintenance diagnostic data, and slave devices may transmit these data to the master device. The master device may comprise a GSM component or other communications module which allows the master device to communicate directly with the back-end server. Thus, the master device may transmit its own usage and maintenance diagnostic information, as well as usage and maintenance diagnostic data received from the slave devices, to the server or to a separate diagnostic device.

According to some embodiments, a system for controlling electrical devices based on usage credits associated with a plurality of electrical devices includes a first controller of a first electrical device, the first controller is configured to receive a first message and a second message generated from an external network, the first message includes a plurality of authentication codes, the second message includes usage credits associated with a second electrical device, the first controller is further configured to extract a first authentication code of the first message, determine whether the first authentication code is valid, and in response to the determination that the first authentication code is valid, transmit a second authentication code of the first message for requesting a first communication link between the first electrical device and the second electrical device; and a second controller of the second electrical device, the second controller is configured to determine whether to establish the first communication link based on the second authentication code of the first message, and if the communication link is established, receive a first portion of the usage credits via the established first communication link for controlling the second electrical device.

In any of these embodiments, the first controller may be configured to determine a second portion of usage credits for controlling the first electrical device.

In any of these embodiments, the first controller may be configured to connect to the external network for receiving the messages and the second controller is configured to be unable to connect to the external network.

In any of these embodiments, the second controller may be configured to stop a function of the second electrical device if the first communication link with the first electrical device has been disrupted for a predetermined amount of time.

In any of these embodiments, the first controller may be configured to transmit a third authentication code of the first message to a third controller of a third electrical device for requesting a second communication link between the first electrical device and the third electrical device, wherein the third electrical device is configured to determine whether to establish the second communication link based on the third authentication code, and if the second communication link is established, the first controller is configured to transmit a second portion of usage credits to the third controller via the established second communication link.

In any of these embodiments, the first controller may be configured to determine the first portion of usage credits and the second portion of usage credits based on a priority value of the second electrical device and a priority value of the third electrical device.

In any of these embodiments, the second controller may be configured to receive a third authentication code of the first message from the first controller via the first communication link, transmit the third authentication code to a third controller of a third electrical device for requesting a second communication link between the second electrical device and the third electrical device, wherein the third electrical device is configured to determine whether to establish the second communication link based on the third authentication code, and if the second communication link is established, the second controller is configured to transmit a second portion of usage credits to the third controller via the second communication link.

In any of these embodiments, the second controller may be configured to update a status of usage credits associated with second electrical device in accordance with the transmitted first portion of usage credits, monitor usage of the second electrical device, and track remaining usage credits based on the status of usage credits and the monitored usage.

According to some embodiments, a method for controlling electrical devices based on usage credits associated with a plurality of electrical devices includes receiving, by a first controller of a first electrical device, a first message and a second message generated from an external network, the first message includes a plurality of authentication codes, the second message includes usage credits associated with a second electrical device; extracting, by a first controller, a first authentication code of the first message; determining, by the first controller, whether the first authentication code is valid; transmitting, from the first controller, a second authentication code of the first message to a second controller of the second electrical device for requesting a first communication link between the first electrical device and the second electrical device in response to the determination that the first authentication code is valid; determining, by the second controller, whether to establish the first communication link based on the second authentication code of the message; establishing the first communication link in response to the determination to establish the first communication link; transmitting, by the first controller, a first portion of usage credits to the second controller via the established first communication link; and controlling, by the second controller, the second electrical device based on the transmitted first portion of usage credits.

In any of these embodiments, the method may include determining, by the first controller, a second portion of the usage credits for controlling the first electrical device.

In any of these embodiments, the method including connecting the first controller to the external network for receiving the messages.

In any of these embodiments, the method may include transmitting, by the first controller, a third authentication code of the first message to a third electrical device for requesting a second communication link between the first electrical device and the third electrical device, determining whether to establish the second communication link, and transmitting a second portion of usage credits to the third controller via the established second communication link.

In any of these embodiments, the method may include determining, by the first controller, the first portion of usage credits and the second portion of usage credits based on a priority value of the second electrical device and a priority value of the third electrical device.

In any of these embodiments, the method may include updating a status of usage credits associated with the second electrical device in accordance with the transmitted first portion of usage credits, monitoring usage of the second electrical device, and tracking remaining usage credits based on the status of usage credits and the monitored usage by the second controller.

According to some embodiments, a system for controlling devices based on usage credits associated with a plurality of electrical devices includes one or more processors; memory; one or more programs, wherein the one or more programs are stored in the memory and configured to be executed by the one or more processors, the programs including instructions for: receiving a first identification information associated with the first electrical device, a second identification information associated with the second electrical device, and usage information associated with the second electrical device; generating a first message that includes a plurality of authentication codes and a second message that includes usage credits based on the first identification, the second identification, and the usage information; transmitting the first message for retrieval at a first controller of the first electrical device for allowing the first controller to establish a first authorized link between the first electrical device and the system based on a first authentication code of the message and for allowing the second controller to establish a second authorized link between the first electrical device and the second electrical device based on a second authentication code of the message; and transmitting the second message for retrieval at the first controller for allowing the first controller to control the second electrical device based on usage credits.

In any of these embodiments, the programs may include instructions for determining which electrical devices are permitted to link based on the received identification information and generating corresponding authentication codes for each permitted link.

In any of these embodiments, generating the first authentication code for the first electrical device may include using a first secret information only known to the system and the first electrical device and generating the second authentication code for the second electrical device may include using a second secret information only known to the system and the second electrical device.

In any of these embodiments, the system may be a remote server.

According to some embodiments, a method for controlling devices based on usage credits associated with a plurality of electrical devices includes receiving, at a remote server, a first identification information associated with the first electrical device, a second identification information associated with the second electrical device, and usage information associated with the second electrical device; generating by the remote server a first message that includes a plurality of authentication codes and a second message that includes usage credits based on the first identification, the second identification, and the usage information; transmitting the first message for retrieval at a first controller of the first electrical device for allowing the first controller to establish a first authorized link between the first electrical device and the remote server based on a first authentication code of the message and for allowing the second controller to establish a second authorized link between the first electrical device and the second electrical device based on a second authentication code of the message; and transmitting the second message for retrieval at the first controller for allowing the first controller to control the second electrical device based on usage credits.

In any of these embodiments, the method may include determining which electrical devices are permitted to link based on the received identification information and generating corresponding authentication codes for each permitted link.

### BRIEF DESCRIPTION OF THE FIGURES

FIG. 1 shows a bundle of PAYG devices, according to some embodiments.

FIG. 2 shows a system for managing and controlling a set of PAYG devices, according to some embodiments.

FIG. 3 is a flowchart that illustrates a process for configuring and deploying a system for managing and controlling a set of PAYG devices, according to some embodiments.

FIG. 4 is a flowchart that illustrates a process for establishing an authorized communication link between a master device and a slave device, according to some embodiments.

FIG. 5 is a state diagram that shows the operational states of a slave device, according to some embodiments.

FIG. 6 is a state diagram that shows operational states of a master device, according to some embodiments.

FIG. 7 is a flowchart that describes the operation of a slave device when it is powered on, according to some embodiments.

FIG. 8 is flowchart that describes the operation of a master device when it is powered on, according to some embodiments.

FIG. 9 is a flowchart that illustrates a process of a server for managing and controlling PAYG devices, according to some embodiments.

FIG. 10 is a flowchart that illustrates a process for establishing an authorized communication link between a master device and a server and for establishing an authorized communication link between the master device and a slave device, according to some embodiments.

### DETAILED DESCRIPTION OF THE DISCLOSURE

Described are devices, systems, and methods for administering and enforcing user rights in electrical appliances. In some embodiments, the systems and methods may include a master device and one or more slave devices. The master device may receive information from an administrator corresponding to a user's authorization to use one or more of the slave devices. The master device may communicate to one or more of the slave devices the current status of the user's authority to use the slave devices and the slave devices may be enabled or disabled according to the current status of the user's rights.

In some embodiments, one or more of the slave devices may be pay-as-you-go (PAYG) electrical appliances. The devices, systems, and methods described herein may allow an end-user to purchase and manage a plurality of PAYG devices under a single account by interacting with only one master device, while prohibiting the user from bypassing the PAYG arrangement by connecting one or more of the devices in the set to an auxiliary power source. The user may make a payment to add usage credit to one or more of the devices in the set and update credit information for all the devices in the set by interacting with only a master device. The master device may securely communicate with slave devices in the set to update their operating status—whether they are enabled or disabled—and their usage credits based on the payment. The slave devices may also communicate with the master to transmit usage or maintenance diagnostic data stored by the slave devices.

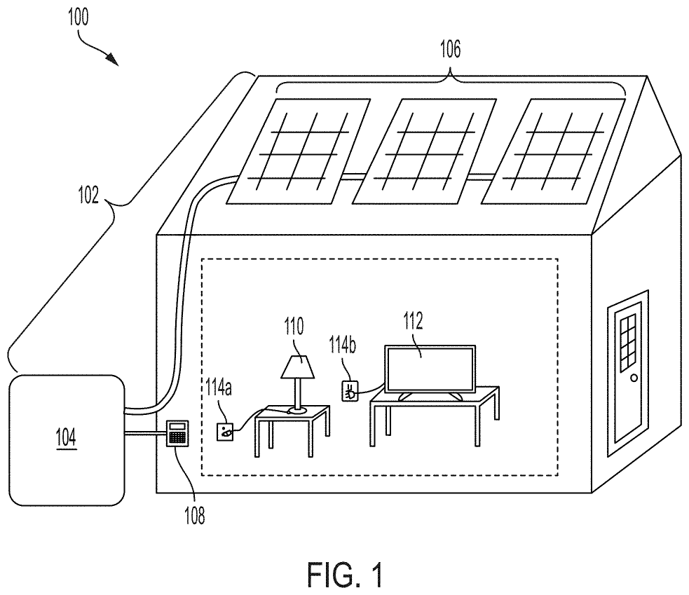

FIG. 1 shows a bundle 100 of PAYG devices, according to some embodiments.

Bundle 100 includes a PAYG solar home installation 102 and PAYG accessory devices lamp 110 and television 112. Solar home installation 102 may include solar panels 106, battery 104, and user interface 108. Solar home installation 102 may include one or more power outlets 114a and 114b. In some embodiments, solar installation 102 may be configured to provide AC or DC power to accessories 110 and 112 through power outlets 114a and 114b. Solar home installation 102, lamp 110, and television 112 may each include an integrated PAYG enforcement mechanism that enables or disables each device independently based on whether the user's account currently includes usage credit for each device. In some embodiments, solar home installation 102 may be the ‘master’ device in the bundle and lamp 110 and television 112 may be ‘slave’ devices.

In some embodiments, a user may purchase and manage the PAYG devices of bundle 100 under a single account. The user may make a payment to the PAYG provider or distributor to add usage credits to one or more of the devices associated with the account. In some embodiments, in exchange for a payment, the user may receive a keycode which contains encoded information corresponding to the payment, such as for which devices the payment added usage credit. The user may enter the keycode into the master device—in this embodiment, solar home installation 102—using user interface 108. The master device may decode the information contained in the keycode and transmit, to the slave devices, updated information corresponding to the updated amount of usage credit associated with each slave device.

In response to the information, slave devices 110 and 112 may be updated to reflect the current amount of usage credit associated with each device and whether the devices should be enabled or disabled. For example, if the payment was for credits associated with lamp 110, the PAYG enforcement mechanism of lamp 110 may be updated to enable lamp 110 for a period of time, based on the payment information. When the credits associated with a device in the bundle, such as television 112, have been exhausted, the integrated PAYG enforcement mechanism of television 112 may disable the device until additional credits are purchased by the user. In this way, slave device television 112 may be disabled even if solar home installation 102 continues to provide power to the device through power outlet 114b or if television 112 is connected to an auxiliary power source.

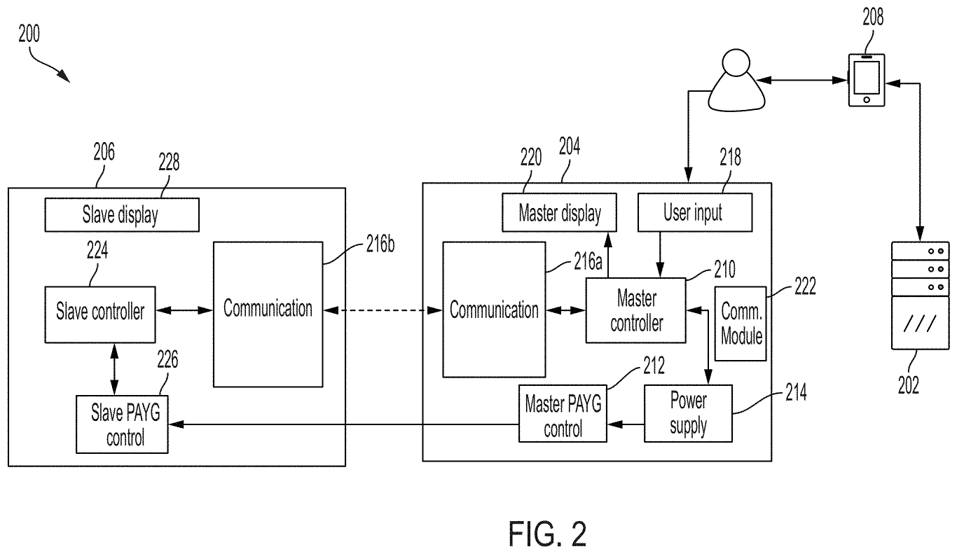

FIG. 2 shows a system 200 for managing and controlling a set of PAYG devices, according to some embodiments. In some embodiments, the system comprises a back-end server 202, a master device 204, one or more slave devices 206, and a user interface device 208. In other embodiments, the system may not include any slave devices or a user interface device. In some embodiments, master device 204 or user interface device 208 may be a smartphone. In some embodiments, master device 204 and slave device 206 may be manufactured by different manufacturers.

Server 202 manages the PAYG system. Server 202 may be a database server, a web server, an application server, or any other type of microprocessor-based device suitable for transmitting, receiving, processing, and/or storing data. Server 202 may comprise multiple servers that may be co-located or located at different locations. In some embodiments, server 202 may comprise cloud computing and storage solutions.

In some embodiments, server 202 may store, in one or more data objects, information uniquely identifying each device in the system. Server 202 may store information indicating that the master device and the slave device are associated with a single account. Server 202 may also store information associated with each device in the system, such as public and/or private device identification numbers, cryptographic keys associated, usage data, maintenance diagnostic data, and/or the amount of usage credit the user has purchased for each device.

In some embodiments, usage credit may represent a period of time for which a device may be used. For example, an appliance may be enabled for a period of time based on the number of credits associated with the appliance, regardless of whether it is turned on or off. Alternatively, an appliance may be enabled for a period of time based on the number of credits associated with the appliance and where the enabled time is only reduced when the appliance is turned on and/or in use. In other embodiments, credits may be based on usage. For example, a PAYG pump may be configured to pump an amount of fluid based on the number of credits associated with the pump. In some embodiments, the rate at which usage credits are decremented may vary. For example, usage credits associated with a television may be configured to decrement more slowly when the television is tuned to certain channels.

In some embodiments, a user may submit a payment using user interface device 208. User interface device 208 may be a computer, a smartphone, a tablet, or other device suitable for transmitting an electronic payment. In some embodiments, user interface device 208 may comprise an application configured to manage the PAYG account and/or accept payments associated with the account. In other embodiments, the user may access a web site suitable for making a payment associated with the PAYG account. Alternatively, the user may make an in-person payment to a PAYG distributor. The distributor may then transmit payment information to server 202.

Server 202 may receive payment information associated with the account. The payment information may include the amount of the payment, the number of PAYG credits purchased, for which devices credits are purchased, or other information. In some embodiments, server 202 may receive payment information directly from user interface device 208. Alternatively, server 202 may receive payment information from a web-server, a cellular communications network, or other intermediate communications device capable of transmitting payment information.

Server 202 may update and store information regarding the devices associated with the user's account based on the payment information. For example, server 202 may increase the number of usage credits associated with the user's account and/or with one or more devices associated with the user's account based on the amount of the payment. Device status information may also be updated by the distributor independent of payments made by a user. For example, a distributor may use a web application to update the operating status or usage credit associated with a device independent of a payment by a user.

In some embodiments, in response to receiving payment information associated with an account or other event affecting the status of a device, server 202 may generate a keycode associated with the account. In other embodiments, back-end server 202 may generate a keycode based on events other than receipt of data corresponding to a payment. Back-end server 202 may generate a keycode in response to any event modifying the operating status or usage credit associated with a device. For example, the operating status and/or usage credit associated with one or more devices may be updated when a device is repossessed by a distributor, when an existing usage credit is associated with a separate bundle or account, when the pricing plan associated with an account is changed, or when other event affecting the usage credit associated with one or more devices occurs.

A keycode may be an alpha-numeric string that encodes information associated with the account and/or the payment. In some embodiments, the keycode may include encoded information identifying for which devices PAYG credit has been purchased and the amount of credit purchased. A keycode may also include authentication information which may authorize master device 204 to securely communicate with slave device 206.

In some embodiments, a keycode may also include information instructing master device 204 how to control the slave devices and/or how to distribute credits among the slave devices. For example, in some embodiments, a user may make a general payment associated with their account that is not associated with a particular device. As long as the account has sufficient credits, all devices may be enabled. However, when there are no longer sufficient credits remaining to enable all devices associated with the account, master device 204 may make determinations regarding how the remaining credits should be allocated among the devices. For example, the keycode may include information instructing master device 204 to prioritize one slave device over all other slave devices when there are insufficient credits remaining in the account to enable all devices.

Alternatively, in some embodiments, a master device may be configured to determine how to distribute credits among the slave devices and the master device itself. In some embodiments, a master device may be configured to prioritize credits based on a predetermined priority value that is associated with each slave device. In some embodiments, the predetermined priority value may be determined by the master device. A master device may also be configured to prioritize credits based on a predetermined “device type” value wherein appliances associated with certain types are prioritized over appliances associated with other types. For example, a household appliance-type appliance—e.g. a refrigerator—may have a higher priority than an entertainment-type appliance—e.g. a television. In some embodiments, the predetermined “device type” value may be determined by the master device.

In some embodiments, the master device 204 may be configured to determine to transmit all credits to one or more connected slave devices. In some embodiments, the master device may be configured to determine to allocate all credits received by the server for controlling the master device. Controlling the master device may include enabling or updating the master device based on the allocated credits.

In some embodiments, master device 204 may include communications module 222. Communications module 222 may allow master device 204 to communicate directly with server 202 over a cellular communications network, WiFi, Bluetooth, GSM, LPWAN, or other communications standard.

In some embodiments, where master device 204 includes communications module 222, server 202 may transmit PAYG information directly to master device 204. In other embodiments, where master 204 does not include communications module 222 or cellular service is unavailable, server 202 may generate and transmit a keycode to user interface device 208. A user may then enter the keycode into master device 204 using user input 218. In some embodiments, user input device 218 may be a numeric keypad, a touchscreen interface, and/or other input device suitable for entering a keycode into master device 204. In some embodiments, user input device 218 may be physically connected to master device 204. In other embodiments, user input device 218 may be separate from master device 204.

In some embodiments, master device 204 may also include master display 220. Master display 220 may display information about master device 204, such as its usage credit, the amount of credit remaining associated with master device 204, whether master device 204 has established a connection to any slave devices, with how many slave devices master device 204 has established a connection, the device ID of the master, the device ID of connected slaves, the time since last connection to one or more slaves, or other information. Master display 220 may comprise an LCD screen, a touchscreen display, a seven-segment display, a series of indicator lights, and/or other components capable of displaying information associated with the network of PAYG devices.

Master device 204 may comprise a controller 210 for decoding the keycode. Additionally, controller 210 may execute PAYG functions associated with master device 204 and/or slave device 206, control the PAYG state of the master device, manage communication with slave device 206 and/or server 202, control master PAYG control 212, process and store usage data and/or maintenance diagnostic data associated master device 204 and/or slave device 206, and/or perform other functions. Controller 210 may also store information associated with master device 204, slave device 206, or other information. For example, controller 210 may store public and/or private keys associated with master device 204, public and/or private device identification numbers associated with master device 204, parameters for managing communication with slave devices, a list of slave devices with which master device 204 is authorized to communicate, the current PAYG state of master device 204, a secret key for authorizing and/or encrypting communication with slave devices and/or server 202, usage data and/or maintenance diagnostic data associated with master device 204, keycode history associated with the account, and/or other information. In some embodiments, the controller 210 may store certificates, public keys, or symmetric keys for allowing secure communication to slave devices. In some embodiments, controller 210 may comprise a microcontroller, a digital signal processor, a programmable logic controller, EEPROM, or other electronic device comprising one or more processors and memory suitable for processing and storing data associated with master device 204 and/or the PAYG network.

Based on the information contained in the keycode, controller 210 may update the PAYG status of master device 204. For example, if the payment added usage credit associated with master device 204, controller 210 may enable master device 204 via master PAYG control 212. Master PAYG control 212 may comprise a power switch or other hardware and/or software capable of enabling and disabling master device 204.

In some embodiments, master device 204 may comprise power supply 214. Power supply 214 may be a battery or other power source. Power supply 214 may be configured to store energy from another power source, such as one or more solar panels. In some embodiments, the one or more solar panels may be operated as slave devices and configured to provide power only if enabled by a master device.

In some embodiments, power supply 214 may supply power to one or more slave devices. In some embodiments, master device 204 may disable all slave devices in the network by disconnecting power supply 214 from the one or more slave devices via master PAYG control 212. Alternatively, master device 204 may disable all slave devices in the network that receive power from power supply 214 by disabling power supply 214.

Master device 204 may further comprise communication device 216a for communicating with slave device 206. Communication device 216a may be a wired or wireless communication interface. For example, communication device 216a may be a component that enables communication over Bluetooth, Bluetooth Low Energy, Zigbee, Z-Wave, Gazelle, Shockburst, Enhanced Shockburst, WiFi, or other wireless communication standard. Alternatively, communication device 216a may be a transceiver that enables communication over a wired communication standard, such as I2C, RS-485, RS-232, UART, Maxim 1-Wire, USB, CAN, LIN, Ethernet, or other wired communication standard.

Slave device 206 may include communication device 216b for communicating with master device 204. Communication device 216b may be a wired or wireless communication interface suitable for communicating with communication device 216a of master device 204. In some embodiments, the slave device 206 does not include a user input for entering information associated with usage credits for controlling the slave device 206. In some embodiments, the slave device is configured to be unable to connect to the server 202. In this way, the slave device 206 relies on receiving/transmiting usage and/or maintenance information only via communication devices 216a and 216b.

In some embodiments, the system 200 may permit a multi-master control scheme in which the system includes more than one master device. If a system includes multiple master device, the communication standard between devices in the system may include a bus arbitration technique to establish priority between the master devices when multiple masters attempt to transmit information and/or instructions simultaneously.

In some embodiments, master device 204 may route information and/or instructions through one or more devices. For example, master device 204 may transmit information and/or instructions intended for a first slave device to a second slave device, along with instructions directing the second slave device to re-transmit the information and/or instructions to the first slave device. In this way, a master device may communicate with a slave device even if the master device cannot directly communicate with the slave device, such as if the slave device is beyond the range of a wireless communication standard implemented by the master device.

Based on the PAYG information received by master device 204, master device 204 may transmit, to slave device 206, information regarding the PAYG status of slave device 206 via communication device 216a. For example, master device 204 may transmit to slave device 206 information instructing slave device 206 to be enabled or disabled. Alternatively, master device 204 may transmit, to slave device 206, information corresponding to an updated amount of usage credit associated with slave device 206, information corresponding to an updated amount of time that slave device 206 may remain enabled. Master device 204 may also transmit information unrelated to operating status or usage credits to slave device 206. For example, server 202 may transmit instructions to master device 204 instructing master device 204 to transmit instructions to slave device 206, such as to update its polling rate for transmitting diagnostic data.

Master device 204 may also transmit to slave device 206 instructions to reset slave device 206 and disconnect slave device 206 from the system. When reset, slave device 206 may be disconnect from the system, disable the associated electrical apparatus, and/or deactivate any links established with other devices in the system.

Slave device 206 may also include a controller 224 for executing PAYG functions associated with slave device 206, controlling the PAYG state of slave device 206, managing communication with master device 204, controlling slave PAYG control 226, processing and storing usage data and/or maintenance diagnostic data associated slave device 206, and/or performing other functions.

Controller 224 may also store information associated with slave device 206. For example, controller 224 may store public and/or private keys associated with slave device 204, public and/or private device identification number associated with slave device 206, parameters for managing communication with master device 204, the current PAYG state of slave device 206, usage data and/or maintenance diagnostic data associated with slave device 206, and/or other information. Controller 224 may comprise a microcontroller, a digital signal processor, a programmable logic controller, EEPROM, or other electronic device comprising one or more processors and memory suitable for processing and storing data associated with slave device 206 and/or the PAYG network.

Based on information received from master device 204, slave controller 224 may update the PAYG status of slave device 206. For example, if the payment added usage credit associated with slave device 206, controller 224 may enable slave device 206 via slave PAYG control 226. Slave PAYG control 226 may comprise a power switch or other hardware and/or software capable of enabling and disabling slave device 206. Additionally, controller 224 may store an updated amount of usage credit associated with slave device 206. Controller 224 may decrement the stored credit value as slave device 206 is used. When the usage credits associated with slave device 206 are exhausted, controller 224 may disable slave device 206 via slave PAYG control 226 without receiving any further information and/or instruction from master device 204. Slave controller 224 may store PAYG status information, such as whether the device is enabled or disabled, and usage credit information in non-volatile memory, such that the PAYG status of the slave device persists across power cycles.

Slave device 206 may include multiple functions that may be managed and controlled independently. For example, a slave device may include both a charging function and a lighting function. Usage credits may be assigned to each function independently, and the PAYG status—whether each function is enabled or disabled—may be controlled independently according to user payments and information and/or instructions received from a master device.

Controller 224 may also store usage and/or maintenance diagnostic data associated with slave device 206. Slave device 206 may transmit the usage and/or maintenance diagnostic data to master device 204. In some embodiments, slave device 206 may transmit such data after receiving information from master device 204. For example, master device 204 may request data from slave device 206. Alternatively, slave device 206 may be configured to transmit such data to master device 204 at periodic intervals, without any prompting from master device 204. Master device 204 may store the data received from slave device 206. If master device 204 includes communications module 222 or other suitable communications device, master device 204 may transmit the slave usage and/or diagnostic data to server 202. If master device 204 does not have a communication connection with server 202, master device 204 may store the data from slave device 206 and/or transmit the data to another device, such as user interface device 208 or a diagnostic device. If master device 204 does not have a communication connection with server 202 or with a diagnostic device, master device 204 may erase the stored data after a predefined period of time or when master device runs out of available memory.

In some embodiments, historical usage and/or diagnostic data stored by one device in the system may be accessed by other devices in the system to dynamically adapt the performance of one or more devices in the system. For example, a device in the system may be configured to update a brightness or speed parameter in response to historical usage and/or diagnostic data stored in another device.

Slave device 206 may also include slave display 228. In some embodiments, slave display 228 may display information about slave device 206, such as its PAYG status, the amount of credit remaining associated with slave device 206, whether slave device 206 has established a connection to master device 204, or other information. Slave display 228 may comprise an LCD screen, a touchscreen display, a seven-segment display, or other components capable of displaying information associated with the network of PAYG devices. In other embodiments, slave display 228 may include one or more indicator lights that indicate whether slave device 206 is enabled, whether slave device 206 has established a connection with master device 204, and/or other information. Slave device 206 may also include a user activated device, such as a button, that may reset the slave device when activated. When reset, slave device 206 may be disconnect from the system, disable the device, and/or deactivate any links established with other devices in the system.

In some embodiments, a single device may operate as both a master and a slave. For example, a first set of devices may be configured to include a first master device and a plurality of slave devices. One or more of the slave devices may be configured to also function as a second master device for a second set of devices wherein the second master device may transmit instructions or information to the slaves associated with the second set of devices in addition to receiving instructions from the first master device. Thus, the second master device may function as both a slave of the first master device and also as a master of the second set of devices. In this way, the first master device may communicate with all of the devices in the second set by transmitting instructions only to the second master device that the second master device may then transmit to the slave devices associated with the second set of devices. For example, the first master device may transmit to the second master device instructions to enable all devices associated with the second set of devices. The second master device may then transmit to all slaves associated with the second set of devices instructions to enable the associated appliances.

The system may also include a diagnostic device for performing maintenance, collecting data, or performing other functions in the system. The diagnostic device may comprise a computer, a smartphone, a tablet, or other device suitable for communicating with other devices in the system. The diagnostic device may be configured to receive diagnostic information from devices associated with the system, such as operating status, linking status, linking information, historical usage data, device ID numbers, and/or other information. The diagnostic device may also be configured to transmit information and/or instructions to devices in the system. The diagnostic device may also include a communication channel that allows the diagnostic device to transmit and receive information to and from server 202.

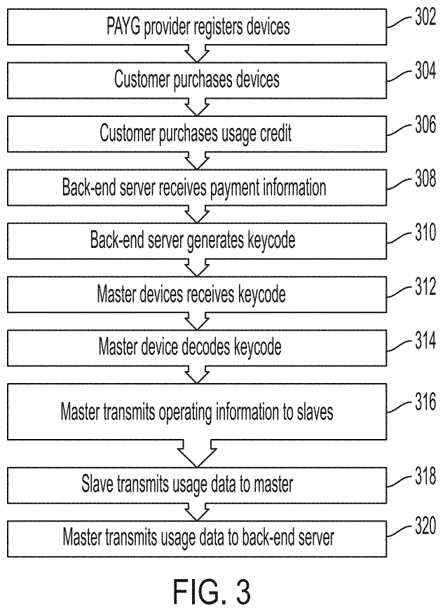

FIG. 3 illustrates a method 300 for configuring and deploying a system for managing and controlling a set of PAYG devices, according to some embodiments. In some embodiments, method 300 may be performed at a system such as system 200 discussed above with reference to FIG. 2. In some embodiments, method 300 may enable a PAYG provider to configure and deploy one or more aspects of a PAYG system, including associating together a bundle of PAYG devices in a single account, receiving payment associated with the account, and enforcing the PAYG arrangement by disabling the devices when PAYG credits have been exhausted.

At step 302, a PAYG provider may register one or more devices by associating one or more identification codes with the devices. For example, a PAYG provider may associate with a device a unique serial number that may be printed on the exterior of the device. Additionally, a PAYG provider may associate with a device a unique identification number that is stored in the device, such as by master controller 210 or by slave controller 224. A PAYG provider and/or device manufacturer may also associate with the device a secret symmetric key to enable secure and or/authorized communication with other devices, which may be stored in each device. The serial number, identification number, and/or secret symmetric key may be stored in server 202 and associated with the device.

At step 304, a customer may purchase one or more devices from a distributor under a PAYG arrangement. When a customer purchases one or more devices, a distributor may transmit to back-end server 202 information indicating that the devices have been purchased by a single customer and should be associated with a single account, such as by user interface device 208. In response to receiving the information, server 202 may generate and store information associating the devices together, such as by associating together the unique identification and/or serial numbers associated with the devices.

At step 306, the customer may make a payment associated with the account to purchase usage credits. For example, the customer may make a payment directly to the PAYG provider by using user interface device 208 or other device capable of making electronic payments. In other embodiments, a customer may make an in-person payment to a PAYG distributor. The PAYG distributor may then transmit information regarding the payment to the PAYG provider. In some embodiments, the payment may include information indicating how the usage credits purchased by the user should be allocated among the devices associated with the account.

At step 308, back-end server 202 may receive data corresponding to the payment. In response to receiving the data, server 202 may update and store information associated with the user's account and/or one or more of the devices associated with the user's account. For example, server 202 may increase the amount of usage credit associated with one or more of the devices associated with the user's account based on the information received corresponding to the payment.

At step 310, in some embodiments, back-end server 202 may generate one or more keycodes associated with the payment. In other embodiments, back-end server 202 may generate a keycode based on events other than receipt of data corresponding to a payment. Back-end server 202 may generate a keycode in response to any event modifying the operating status or usage credit associated with a device. For example, the operating status and/or usage credit associated with one or more devices may be updated when a device is repossessed by a distributor, when an existing usage credit is associated with a separate bundle or account, when the pricing plan associated with an account is changed, or when other event affecting the usage credit associated with one or more devices occurs.

The keycode may encode updated information regarding the user's account and/or devices associated with the user's account based on the payment or other information. For example, the keycode may contain information identifying, based on the unique identification number and or serial number associated with a device, the devices for which usage credited has been updated and/or an updated amount of credit associated with each device. The keycode may contain other information such as how to manage the set of devices. For example, the keycode may encode information indicating how usage credit should be allocated among the devices. The keycode may also contain information indicating that a device has been removed from the system and/or user account and instructions directing the master device to disable the device and remove the device from the system.

The keycode may also contain cryptographic information which authorizes a master device to communicate with a slave device. In other embodiments, server 202 may transmit the information contained in the keycode directly to a master device without encoding the information into a keycode.

At step 312, in some embodiments, master device 204 receives the keycode. In some embodiments, server 202 may transmit the keycode to user interface device 108. The customer may then manually input the keycode into master device 204, such as by user input 218. In other embodiments, server 202 may transmit the keycode to the PAYG distributor, and the customer may then input the keycode into master 204. Alternatively, in some embodiments, server 202 may include a GSM radio or other communication device that allows master device 204 to communicate directly with server 202. In such a case, server 202 may transmit the keycode directly to master device 204 over GSM, WiFi, or other wireless communication system. In other embodiments, master device 204 may receive the information contained in the keycode directly from server 202, without the information having been encoded into a keycode.

At step 314, master controller 210 may decode the keycode to retrieve the information associated with the payment. If the decoded includes information regarding master device 204, master controller may update information stored in controller 210 and/or store new information in controller 210 and/or perform other functions. For example, if the payment added usage credit to master device 204, controller 210 may enable master device 204 via master PAYG control 212 and/or update and store information corresponding to the updated amount of credits associated with master device 204.

At step 316, master device 204 may transmit, by communication device 216a, information and/or instructions to one or more slave devices. For example, if the payment added usage credit to slave device 206, master device 204 may transmit, to slave device 206, information instructing slave controller 224 to enable slave device 206 via slave PAYG control 226. Master device 204 may also transmit to slave device 206 information indicating the current amount of credit is associated with slave device 206 based on the payment. Slave controller 224 may store the amount of credit associated with slave device 206 and decrement the stored value as slave device 206 is used.

In some embodiments, slave controller 224 may store usage data and/or maintenance diagnostic data regarding slave device 206. At step 318, slave device 206 may transmit, by communication device 216b, usage data and/or maintenance diagnostic data regarding slave device 206 to master device 204. In some embodiments, slave device 206 may transmit such data after receiving information from master device 204. Alternatively, slave device 206 may be configured to transmit such data to master device 204 at periodic intervals, without any prompting from master device 204. In some embodiments, master device 204 may store the data received from slave device 206.

At step 320, master device 204 may transmit usage data and/or maintenance diagnostic data regarding itself and/or one or more slave devices to server 202 and/or to other devices. If master device 204 includes communications module 222 or other suitable communications device, master device 204 may transmit the slave usage and/or diagnostic data to server 202. If master device 204 does not have a communication connection with server 202, master device 204 may store the data from slave device 206 and/or transmit the data to another device, such as user interface device 208 or a diagnostic device. If master device 204 does not have a communication connection with server 202 or a diagnostic device, master device 204 may erase the stored data after a period of time or when master device 204 runs out of available memory.

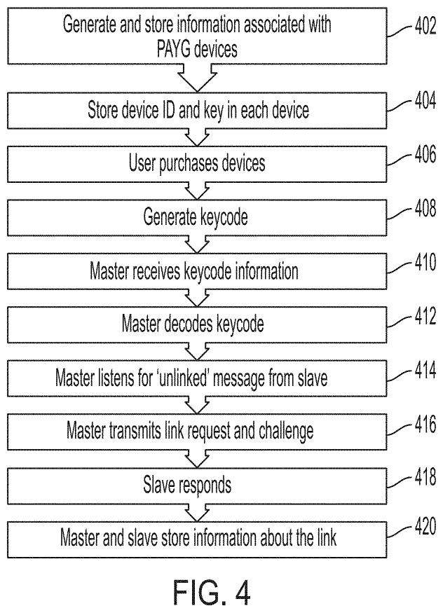

FIG. 4 illustrates a method 400 for establishing an authorized communication link between a master device and a slave device, according to some embodiments. In some embodiments, method 400 may be performed at a system such as system 200 discussed above with reference to FIG. 2. In some embodiments, master device 204 may only be able to communicate with slave devices associated with the same user account. Before a master device can communicate with a slave device, the devices must be “linked” by establishing that the master device is authorized to communicate with the slave device. In some embodiments, the server 202 designates which devices may be “linked” and provides information associated with the one or more designated links in a keycode that is received by the master device.

At step 402, server 202 may generate and store identification information associated with each PAYG device. As described above, in some embodiments, server 202 may generate and store a unique device ID, a secret symmetric key, and a public key associated with each PAYG device. In some embodiments, a device's device ID and secret symmetric key are not publicly available and are known only to the device itself and to back-end server 202. In some embodiments, the device ID may comprise a MAC address or Bluetooth address.

At step 404, a device ID and secret symmetric key may be stored in each device. The device ID and secret symmetric key may be stored in controllers 210 and 224. In some embodiments, the device ID and secret symmetric key may be stored in the devices at the time they are manufactured. In other embodiments, the device ID and secret symmetric key may be stored in the devices at a later time.

At step 406, a user may purchase one or more devices under a single account. As above, when a user purchases one or more devices under a single account, server 202 may generate and store information associating the devices with the account. Server 202 may also designate one of the devices as the master device associated with the account. Server 202 may designate the remaining devices associated with the account as slave devices. A user may also purchase usage credits associated with the account.

At step 408, after receiving payment information, server 202 may generate a keycode that encodes the device ID of a slave device, a corresponding challenge result for the slave device, and a one-time-use challenge ID for each device. Transmission of a challenge result, either alone or in combination with other information related to the challenge result (such as a challenge ID), may be referred to as a “challenging” the receiving device to match the transmitted challenge result. Accordingly, a challenge result may also be referred to as a challenge. The challenge ID may be a nonce stored on the server 202 and the receiving device. In some embodiments, the challenge result may be a message authentication code (MAC), a digital signature, or a nonce. The challenge ID of a device may be used in the computation of its challenge result to prevent replay attacks.

The keycode may also contain PAYG status information associated with the slave and/or device. In some embodiments, the challenge result for a slave device may be generated cryptographically based on the public key and secret symmetric key associated with a slave device. The challenge result for a slave device may also be generated based on public-key cryptography, wherein the challenge result may be encrypted based on a public key associated with the master device and can only be decrypted based on a secret key associated with the slave device and known only to the slave device and the server. In some embodiments, the challenge result may be a cryptographic hash. For example, to create a challenge result for a slave device, the server may combine the public key associated with the master device with a one-time-use challenge ID and then generate a cryptographic hash of the result based on the secret symmetric key associated with the targeted slave device. In some embodiments, the challenge result for the slave device may be generated based only on the symmetric secret key of the targeted slave device that is known only to the targeted device and to the server 202.

In some embodiments, the server may transmit the challenge result for the slave device and the challenge ID to the master device, which may transmit the challenge, the challenge ID, and the public key of the master device to the targeted slave device. In some embodiments, the server may transmit the challenge result for the slave device and a portion of the challenge ID to the master device, which may transmit the challenge result, the portion of the challenge ID, and the public key of the master device to the targeted slave device. In some embodiments, the server may transmit the challenge result for the slave device and not the challenge ID to the master device, which may transmit the challenge result and the public key of the master device to the targeted slave device. In some embodiments, if the challenge ID is transmitted, the receiving device can check the transmitted challenge ID and ensure that the devices internal notion of the challenge ID is less than or equal to the transmitted challenge ID. If the device knows that its internal challenge ID is equal or above the transmitted challenge ID, then the device will not attempt to validate the challenge result. This is because the device has determined that this is an ‘old’ message, which it should ignore (the challenge ID is ‘already used’).

In some embodiments, if part of the challenge ID is transmitted (for example, the last ‘digit’ of the challenge ID), then the receiving device can check the transmitted challenge ID and then check the devices current challenge ID. To save time computing the challenge result, the device may only compute the challenge result using challenge ID that ends with a value that matches the transmitted portion of the challenge ID. For example, if the device has a current challenge ID of ‘51’ and receives a ‘truncated’ challenge ID of ‘2’, the device will compute the challenge result using a challenge ID of 52 and 62 (and possibly higher, depending on how far the device is configured to ‘look ahead’). In some embodiments, the device may be configured to ‘looks ahead’ 20 counts. For example, the device may first compute the challenge result using a challenge ID of ‘52’. If that result doesn't match, the device may computer the challenge result again using a challenge ID of ‘62’. If that also doesn't match, the device rejects the message. In some embodiments, if no challenge ID is transmitted, the receiving device must ‘guess’ the challenge ID used to create the challenge result for the message. For example, if the device internal nonce/challenge ID is ‘51’, and the message MAC was computed with a nonce/challenge ID 55. Then, the device will do the following: Compute challenge result using challenge ID ‘52’, if the challenge ID does not match the internal challenge ID, then compute the challenge result using challenge ID ‘53’, if the challenge ID still does not match the internal challenge ID, then compute the challenge using challenge ID ‘54’, if the challenge ID still does not match the internal challenge ID, then compute the challenge result using challenge ID ‘55’. In this example, challenge ID ‘55’ matches the internal challenge ID of the device, so the message is validated.

At step 410, the keycode may be transmitted to the master device. As described above, in some embodiments, master device 204 may include communications module 222. Communications module 222 may allow master device 204 to communicate directly with server 202 over a cellular communications network, the Internet, or other communications network. In some embodiments, where master device 204 includes communications module 222, server 202 may transmit the keycode directly to master device 204. In other embodiments, where master 204 does not include communications module 222 or cellular service is unavailable, server 202 may transmit the keycode to user interface device 208. A user may then enter the keycode into master device 204 using user input 218. In some embodiments, user input device 218 may be a numeric keypad, a touchscreen interface, or other input device suitable for entering a keycode into master device 204.

At step 412, the master device may decode the keycode to retrieve the device ID, the challenge result of the slave device, the challenge ID associated with the slave device, and/or other information.

At step 414, the master device may listen for a device broadcasting the device ID contained in the keycode and a message indicating that the slave device is not currently linked with any master device.

At step 416, if the master receives a transmission such as described at step 414 above, the master may transmit a link request, the challenge result associated with the slave device, the challenge ID associated with the slave device, and the public key of the master device to the broadcasting device. Based on the received information, the targeted slave device may determine whether the server authorized the master device to communicate with the targeted slave device by independently computing the challenge result of the slave device in the same manner as the server based on the challenge ID associated with the slave device and the public key of the master. If the challenge result independently generated by the slave device does not match the challenge result received by the slave device from the master device, the slave device may reject communication from the master device. If the challenge result independently generated by the slave device matches the challenge result received by the slave device from the master device, the slave device may accept communication from the master device and/or transmit a response to the master device encrypted with the public key of the master device.

At step 418, the slave device may respond to the link request transmitted by the master device. If the slave is already linked with a separate master device, the slave device may reject the link request. Similarly, if the challenge result is invalid—that is, if the challenge result is not correctly associated with the slave device's secret symmetric key—then the slave device may reject the link request. If the challenge result is correct and the slave device is not currently linked with another master device, the slave device may accept the link request. In some embodiments, a slave device may be configured to accept instructions from an unauthorized device to enable product functionality for a limited period of time, such as for maintenance purposes.

At step 420, the master device and slave device may update a status based on the link created between them. For example, slave controller 224 may generate and store information indicating that the slave device is currently linked with a master device. Additionally, master controller 210 may generate and store information indicating that it is linked with at least one slave device. Master controller 210 may also generate and store information indicating the particular slave device to which it linked and/or store the device ID associated with the slave device in a list comprising all the slave devices with which the master device is currently linked.

In some embodiments, steps 414, 416, 418, and 420 may be executed for establishing authorized links between the master device and additional slave devices based on a plurality of link requests and a plurality of challenge results included in the keycode generated by the server. Each challenge result of the keycode authorizes a specific link. For example, a first challenge result associated with a first slave device may authorize a link between the first slave device and the master device, and a second challenge result associated with a second slave device may authorize a link between the second slave device and the master device.

In some embodiments, the master device may transmit usage information and application-specific commands associated with the slave device to the slave device via a link established in response to an accepted link request between the slave device and the master device. Examples of application-specific commands may include commands for turning of a burner or turning off a heater.

In some embodiments, master controller 210 and/or slave controller 224 may be programmed with a “bond time” parameter that defines a period of time after which a link between the devices may expire. The bond time may be a fixed time interval after which either the master device or slave device may terminate the link. After the bond time has expired, master controller 210 and/or slave controller 224 may update and store data associated with the link between the devices. For example, slave controller 224 may generate and store information indicating that it is not currently linked with a master device. Similarly, master controller 210 may generate and store information indicating that it is not linked with the slave device for which the bond time has expired. Further, master controller 210 may remove the device ID of the slave for which the bond time has expired from a list of slave devices to which the master device is linked.

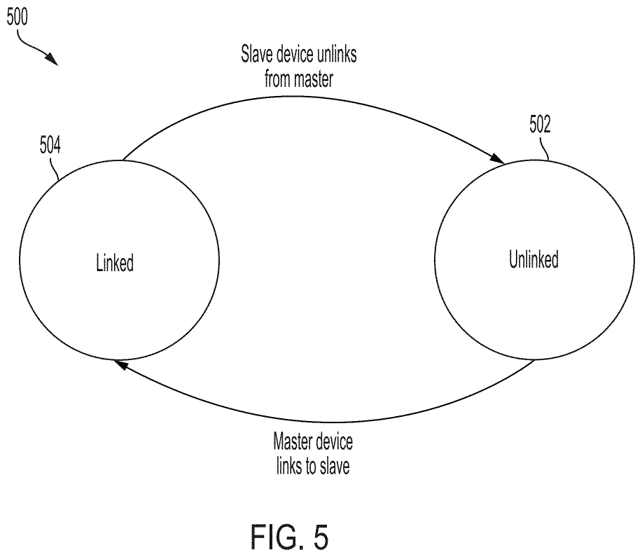

FIG. 5 is a state diagram 500 that shows operational states of a slave device, according to some embodiments. In some embodiments, a slave device may be initially configured to be in an unlinked state 502. A slave device may remain in an unlinked state until a master device successfully links with the device by transmitting a link request with an appropriate challenge result, as described in method 400, above. In some embodiments, when a slave device is in an unlinked state, its PAYG status may be disabled, regardless of the amount of usage credit associated with the device. In other embodiments, a slave device may be configured to be disabled if it does not successfully connect to a master device within a predetermined amount of time.

In some embodiments, a slave device is not a standalone device and relies on the linked state to enable one or more PAYG functions of the slave device. The one or more PAYG functions may include a primary application-based PAYG function. In some embodiments, the PAYG functions of a slave device may be limited if the slave device is not linked to a master device. For example, regarding a slave PAYG lighting device—when the lighting device is not linked to a master device, the lighting device may be limited to provide only a low lighting level. However, when the lighting device is linked to a master device, the lighting device may be enabled to provide a full range of lighting levels. For example, regarding a slave PAYG agricultural pump—when the agricultural pump is not linked to a master device, the agricultural pump may be limited to a predetermined amount of pumping time or pumping power per day. However, when the agricultural pump is linked to a master device, the agricultural pump may be enabled to provide unlimited pumping time or pumping power per day. Another example of a PAYG function of a slave device include displaying the content associated with one or more channels on a PAYG television. In some embodiments, a non-standalone slave device may not have a user input device for receiving usage information from a user to enable one or more functions of the slave device. Instead, the non-standalone slave device may rely only on usage information received by a master device for enabling the one or more PAYG functions of the slave device.

A slave device may display, such as by slave display 206, that it is currently in an unlinked state. When a slave device is in an unlinked state, it may be configured to periodically broadcast a message indicating the device ID of the slave device and/or that the device is currently unlinked.

When a slave device successfully links with a master device, the slave device may enter a linked state 504. A slave device may remain in a linked state until a bond time expires, until the master decommissions the link, or until the slave decommissions the link. In some embodiments, a slave device may be configured to be able to be reset, such as by a physical button or software instruction, after which all links associated with the slave device may be decommissioned. In some embodiments, a keycode generated by the back-end server may be required to reestablish a link that has been decommissioned.

When a master device successfully links with a slave device, the slave device may store in nonvolatile memory information associated with the link, such that the link is not lost if the slave loses power. When a slave device is in a linked state, it may receive and store in nonvolatile memory information from the linked master, such as an updated amount of usage credits associated with the slave device, such that the slave device may track and enforce user rights in the slave device without further communication from the master. In some embodiments, a slave device may display, such as by slave display 206, that it is currently in a linked state and/or to what devices it is currently linked. When a slave device is linked, slave controller 224 may generate and store in nonvolatile memory a bond time data entry that slave controller 224 may decrement until the bond time expires, at which time the slave device may enter an unlinked state 502. Alternatively, the slave device may enter an unlinked state 502 if it receives a communication from the master device that the link has been decommissioned.

In some embodiments, a slave device may enter a non-PAYG mode in which the slave device does not rely on a master device to determine the operational status of the associated electrical device. For example, a master device may instruct a slave device to enter a non-PAYG state in which the slave device is either permanently enabled or disabled regardless of usage credit.

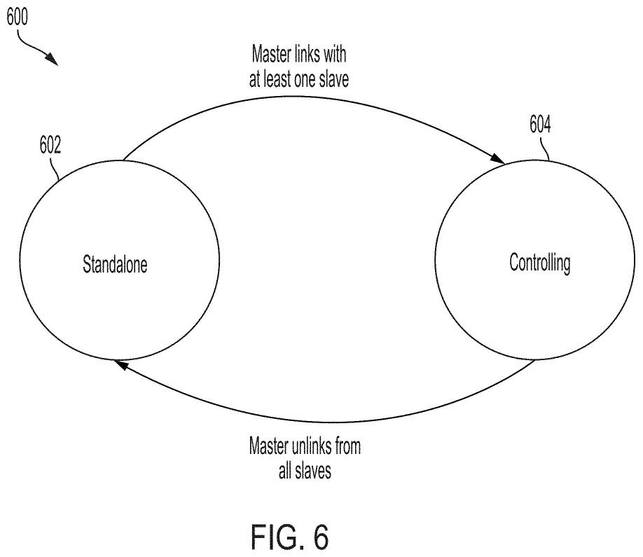

FIG. 6 is a state diagram 600 that shows operational states of a master device, according to some embodiments. In some embodiments, a master device may be initially configured to be in a standalone state 602. A master device may remain in a standalone state until it successfully links with at least one slave device. In some embodiments, when a master device is in a standalone state, it may be a fully operational PAYG device. That is, it may receive information, either directly from server 202 or from a keycode entered by a user, adding usage credit associated with the master device, and enable the device. A master device may also receive information, either directly from server 202 or from a keycode entered by a user, instructing the master device to attempt to link with one or more slave devices.

If a master device successfully links with at least one slave device, it may enter a controlling state 604. In some embodiments, when a master device is in a controlling state, it may continually or periodically listen for transmissions from the slave devices to which it is linked. The master device may store a list in nonvolatile memory, for example in master controller 210, which contains a list of all the slave devices to which the master is currently linked. The master device may also store in nonvolatile memory a data entry associated with each slave to which the master is linked that indicates the amount of usage credit associated with each slave. When a master device is in a controlling state, it may continue to receive information, either directly from server 202 or from a keycode entered by a user, updating PAYG information associated with the master or any of the slaves to which the master is linked.

When a master device is in a controlling state, master controller 210 may generate and store in nonvolatile memory a bond time data entry associated with each slave device to which the master is linked. Master controller 210 may decrement each bond time entry until the bond time expires, at which time the master device may remove the slave device for which the bond time has expired from the stored list of slave devices to which the master is linked. If the bond time expires for all slave devices to which a master has linked, the master device may enter a standalone state 602. Alternatively, a master device may enter a standalone state 602 if it receives instructions, such as from server 202, to decommission every link it has established.

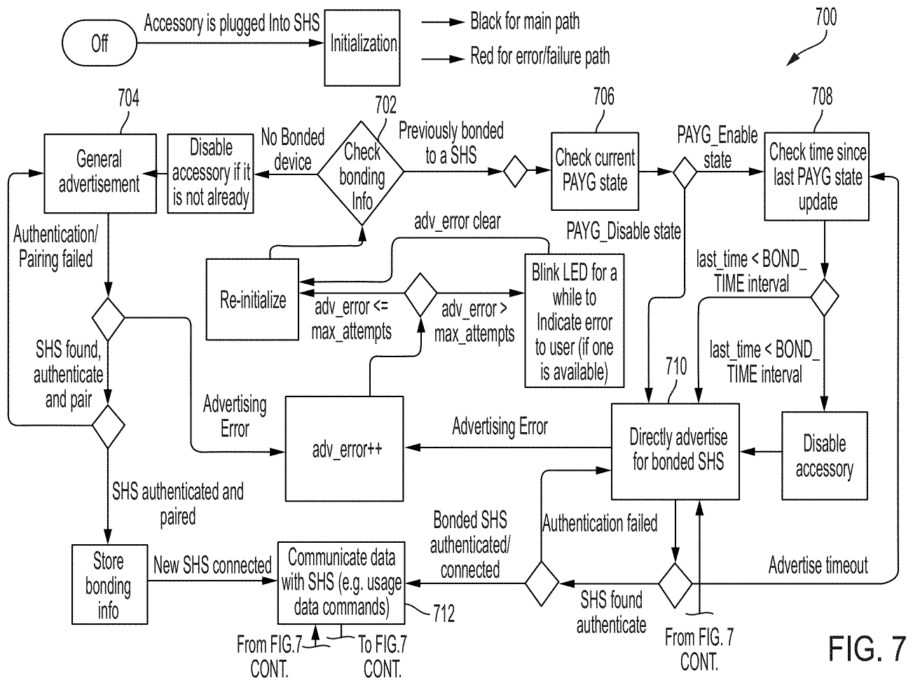

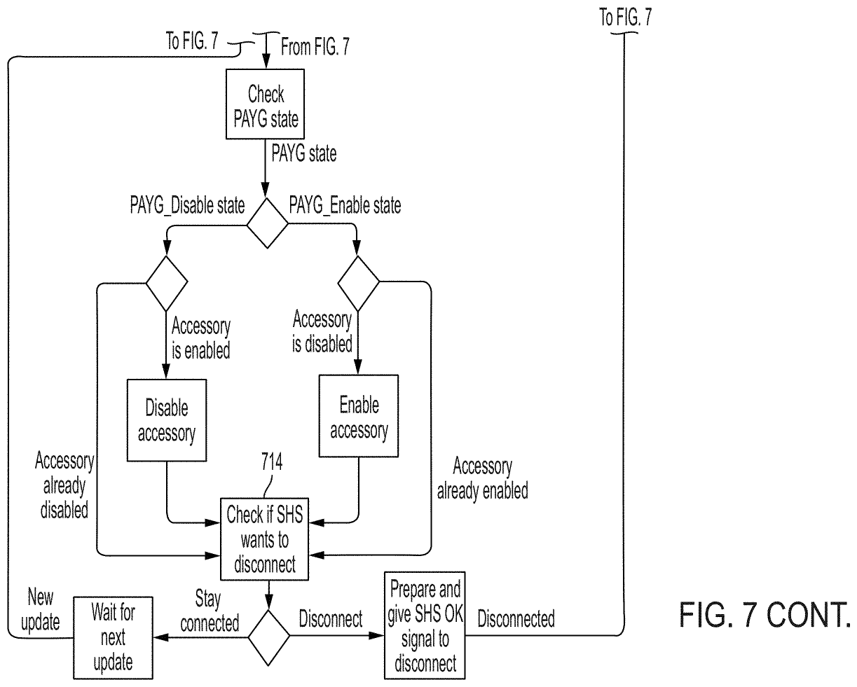

FIG. 7 is a flowchart 700 that describes the operation of a slave device when it is powered on, according to some embodiments. When a slave device is powered on, it may attempt to connect to a master device to which it was linked before the slave device powered off. If the slave device is able to connect with a master device, the slave device may update its operating status based on communication with the master device.

At step 702, after powering on, a slave device may check if the slave device has stored in memory, such as in slave controller 224, information indicating that the slave device was linked to a master device before the slave device was powered off. If there is no information stored in memory indicating that the slave device was linked to a master device before it was powered off, the slave device may enter a disabled and/or unlinked state.

After the slave device has entered a disabled and/or unlinked state, the slave device may begin broadcasting a general advertisement at step 704, such as described in step 410 of method 400, above. The slave device may broadcast, such as by communications device 216b, a general advertisement indicating that the slave device is not linked to a master device. The slave device may also broadcast its device ID.

If, at step 702, the slave device determines that it has information stored in memory indicating that it was linked to a master device prior to powering off, the slave may check its current operating status at step 706. The operating status may be stored in memory, such as in slave controller 224, and may reflect the PAYG status of the device prior to having been powered off.

If the slave device is in a disabled state, the slave device may broadcast a direct advertisement for the master device to which it was linked prior to powering off at step 710. Alternatively, if the slave device is in an enabled state, the slave device may, at step 708, check the time that has passed since the slave device received a PAYG status update from the master to which it was linked. If the elapsed time is greater than a predetermined bond time, then the slave device may enter a disabled state and attempt to re-establish the link with the master device by advertising for the master device at step 710. If the elapsed time is less than the predetermined bond time, then the slave device may remain in an enabled state and attempt to initiate communication with the master device by advertising for the master device at step 710.

If the slave device is able to establish a communication link with a master device, either by a general advertisement of step 704 or a direct advertisement of step 710, the slave device may communicate with the master device. For example, the slave device may transmit to the master device usage data and/or maintenance diagnostic data, such as stored in slave controller 224. The master device may transmit to the slave device updated PAYG information, such as whether the slave device should be in an enabled or disabled state and/or the amount of usage credit associated with the slave device.

Based on the communication with the master device, the slave device may enter an enabled or disabled state to enable or disable the accessory device accordingly. At step 714, after the slave device has updated its PAYG status, the slave device may check whether the master device has transmitted information indicating that the master device will disconnect from the slave device. If the devices are disconnected, the slave device may begin transmitting a direct advertisement for the master device, such as at step 710, and wait for the master device to acknowledge the advertisement and re-initiate a connection. If the master device has not transmitted indicating that the master device will disconnect from the slave device, the slave device may remain connected to the master device and wait for additional communication from the master device, such as at step 712.

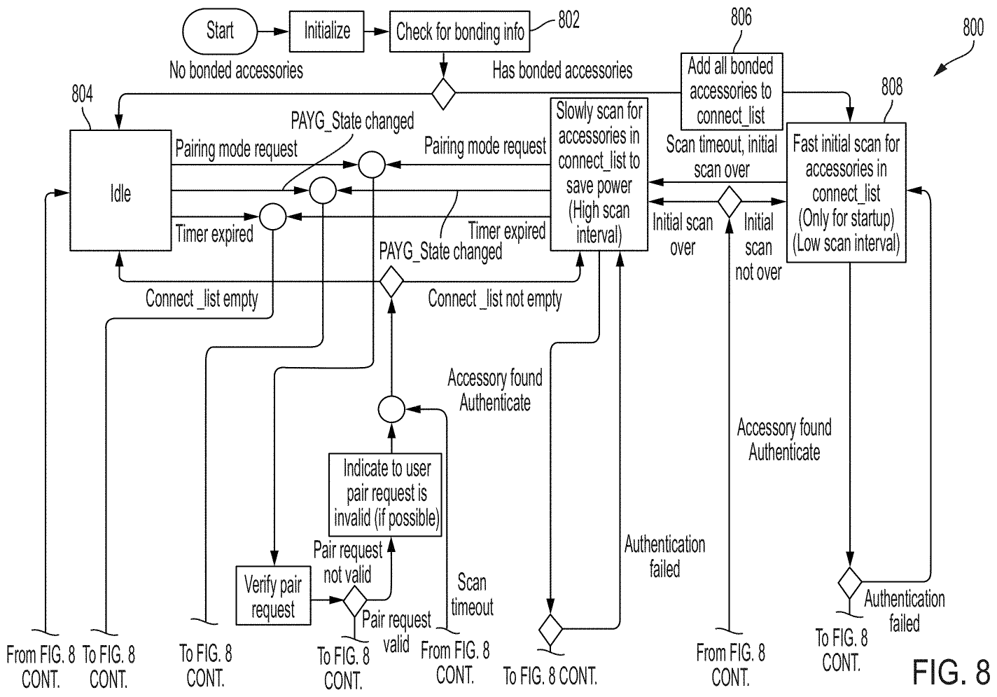

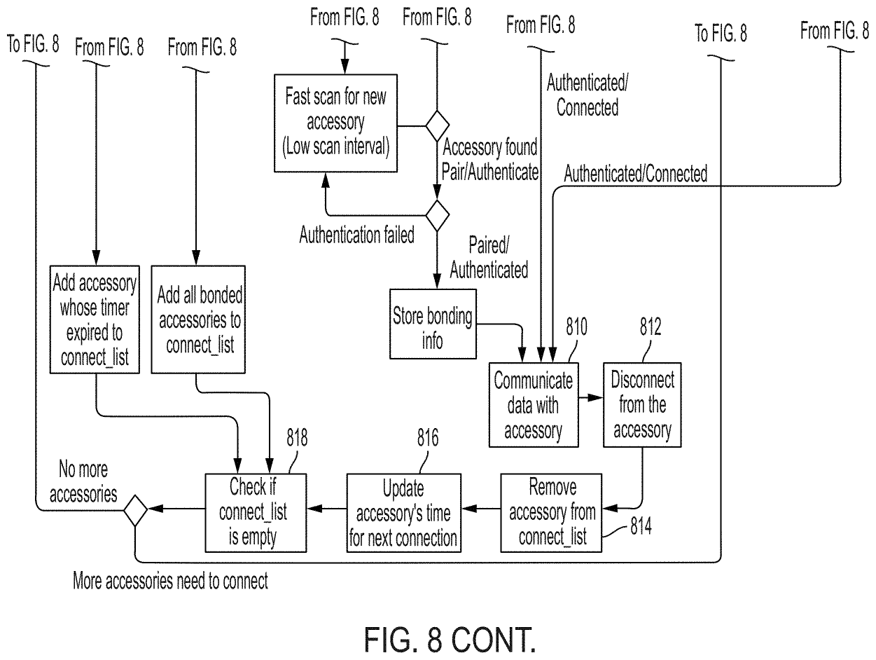

FIG. 8 is a flowchart 800 that describes the operation of a master device when it is powered on, according to some embodiments. As described above, a master device may store, in nonvolatile memory, information regarding any slave devices to which it has linked. When a master devices powers on, it may attempt to re-establish a connection with each slave device to which it was linked prior to powering off and communicate with each slave device.

At step 802, after powering on, a master device may check if any information is stored in the memory of the master device indicating that it was linked to one or more slave devices before powering off. If no such information exists, the master device may enter an idle state at step 804 and await instructions from server 202, either from server 202 directly or in the form of a keycode entered by a user.

If the master device does locate information describing previously linked slave devices at step 802, the master device may, at step 806, add each slave device to a list containing slave devices for which the master device has information to communicate. At step 808, the master device may begin attempting to communicate, one at a time, with each slave device on the list. For each slave device on the list, the master device may attempt to authenticate a connection with the slave device. If the authentication fails for a slave device, the master device may move to the next device on the list. If the authentication succeeds, the master device may, at step 810, communicate with the slave device, such as by transmitting the current PAYG status of the slave device, the number of usage credits associated with the slave device, and/or receiving data from the slave device.

After the master device has communicated with the slave, the master device may, at step 812, disconnect from the slave device. After disconnecting, the master device may, at step 814, remove the slave device from the list of slave devices for which the master device has information to communicate. At step 816, the master device may update a data entry associated with the slave device indicating a time at which the master device should attempt to re-connect with the slave device. At step 818, the master device may check if the list of slave devices with for which the master device has information to communicate is empty. If the list is empty, the master device may enter an idle state at step 804. If the list is not empty, the master device may attempt to authenticate a connection with a slave device remaining on the list.

A master device that has entered an idle state at step 804 may remain in the idle state until it receives information, either directly from server 202 or from a keycode entered by a user, indicating that the master should attempt to link to a new slave device or indicating that the PAYG status of a slave device to which the master device has already linked has been updated. A master device may also leave the idle state at step 804 if a timer associated with a slave device to which the master has already linked expires, indicated that the master should attempt to re-connect with the slave device.

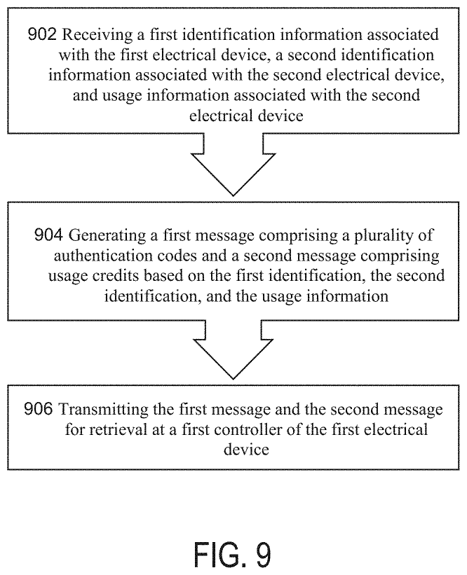

FIG. 9 illustrates a method 900 for managing and controlling a set of PAYG devices by an external network, according to some embodiments. In some embodiments, method 900 may be performed at a system such as system 200 discussed above with reference to FIG. 2.

At step 902, a back-end server (such as back-end server 202 of FIG. 2) may receive identification information and usage information for a plurality of PAYG devices. In some embodiments, the server receives the identification information and/or usage information from a master device (such as master device 204 of FIG. 2) or from a PAYG distributor. For example, the back-end server may receive from a controller of the master device identification information associated with the master device itself, identification associated with a slave device, and usage information associated with the slave device. Identification information may include public and/or private device identification numbers and cryptographic keys associated with each device. Usage information may include usage data, maintenance diagnostic data, and/or the amount of usage credit the user has purchased for each device. In some embodiments, the server may receive identification information and/or usage information for a plurality of slave devices and for the master device.

At step 904, the back-end server may generate a first message (such as a first keycode) that includes a plurality of challenge results that are also generated by the server for authenticating link requests. An example of a challenge result includes a message authentication code (MAC). The plurality of challenge results may include a master device challenge result for authenticating communication from the server. The master device challenge result may be generated based on a master secret symmetric key and public or private data known to the master device and the server. In some embodiments, the master device challenge result may be a hash code based on the public or private data and the master secret symmetric key. The plurality of challenge results may also include one or more slave device challenge results (such as the slave device challenge result described in reference to FIG. 4) for determining whether the server authorized the master device (such as master device 204) to communicate with the slave device (such as slave device 206). At step 904, the back-end server may also generate a second message (such as a second keycode) that includes PAYG usage credits associated with one or more of the PAYG devices, for example a PAYG slave device. The usage credits for a particular device may be generated by the server based on associated identification information and usage information received by the server.

In some embodiments, a keycode is generated based on one or more constraints. For example, the keycode may be constrained to decimal digits (0-9) and/or constrained to fit into a specific number of digits. In some embodiments, the specific number of digits may be at least 3 digits, 6, digits, 9 digits, 12, digits, or 15 digits. In some embodiments, the specific number of digits may be at most 15 digits, 12 digits, 9 digits, 6 digits, or 3 digits. In some embodiments, a final state of the keycode transmitted from the server may be longer than the specific number of digits in which it was originally constrained due to integrity checks and overhead digits for transmitting the keycode.

In some embodiments, a keycode may include a descriptor for describing a purpose (for example, creating a link and/or using the challenge result associated with the slave device) of the keycode, a body field specific to the descriptor for describing the slave device that is to be linked the master device, and a plurality of challenge results for authenticating communication.

In some embodiments, the master device challenge result of the first keycode may be based on least significant decimal digits of a master cryptographic hash generated by the server. In some embodiments, the least significant decimal digits of the master cryptographic hash may be at least 3-decimal digits, 4-decimal digits, 5-decimal digits, 6-decimals digits, 7-decimal digits, 8-decimal digits, 9-decimal digits, or 10 digits. In some embodiments, the least significant decimal digits of the master cryptographic hash may be at most 10-decimal digits, 9-decimal digits, 8-decimal digits, 7-decimal digits, 6-decimal digits, 5-decimal digits, 4-decimal digits, or 3 decimal-digits. The master cryptographic hash may be generated based on the descriptor, the body field, and digits of the slave device challenge result.

In some embodiments, the slave device challenge result of the first keycode may be based on least-significant decimal digits of a slave cryptographic hash generated by the server. In some embodiments, the least significant decimal digits of the slave cryptographic hash may be at least 2-decimal digits, 4-decimal digits, 6-decimals digits, 8-decimal digits, 10-decimal digits, or 12-decimal digits. In some embodiments, the least significant decimal digits of the slave cryptographic hash may be at most 12-decimal digits, 10-decimal digits, 8-decimal digits, 6-decimal digits, 4-decimal digits, or 2-decimal digits. The slave cryptographic hash may be generated based on the master public key, the challenge ID, and the secret symmetric key associated with the targeted slave device. In some embodiments, the master device does not examine the slave device challenge result, but will transmit the slave device challenge result to the targeted slave device for establishing an authorized link between the targeted slave device and the master device.

In some embodiments, a keycode may have a structure that is not “visibly” obvious between different iterations of same keycode types. In some embodiments, the keycode includes at least 2 digits, 4 digits, 6 digits, 8 digits, 10 digits, or 12 digits dedicated to authentication. In some embodiments, the keycode includes at most 12 digits, 10 digits, 8 digits, 6 digits, 4 digits, or 2 digits dedicated to authentication. The split of how many digits are dedicated to the master device versus one or more slave devices may depend on the purpose of the keycode.

At step 906, the back-end server may transmit the first keycode for retrieval at a master device. At step 906, the back-end server may also transmit the second keycode for retrieval at a master device. In some embodiments, the server may transmit one or more keycodes to a controller of the master device via a communication module (such as communication module 222). In some embodiments, the server may transmit one or more keycodes to a user interface (such as user interface 208) associated with the master device.

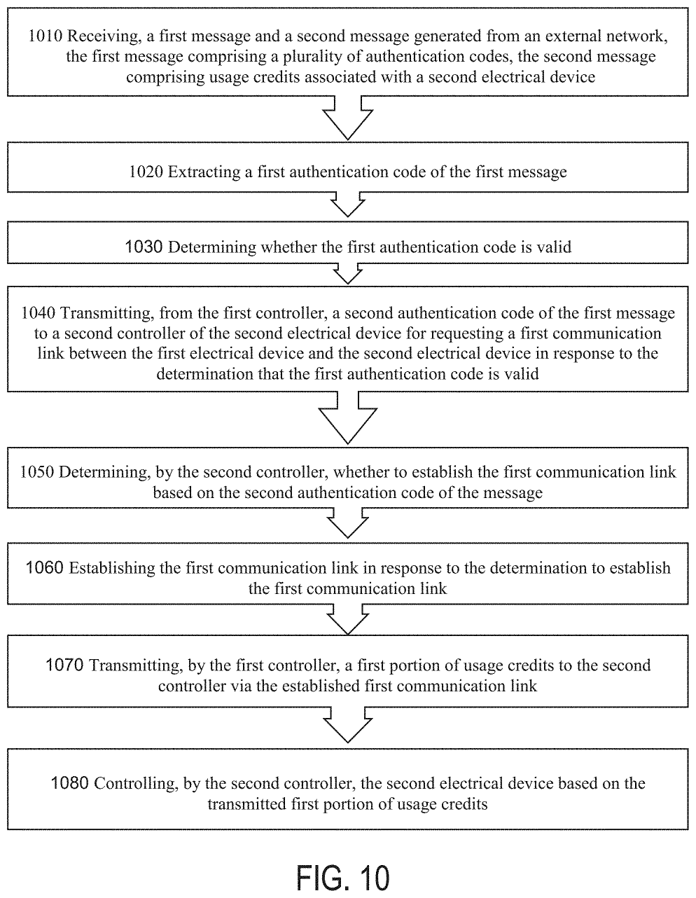

FIG. 10 illustrates a method 1000 for establishing an authorized communication link between a master device and a server and for establishing an authorized communication link between the master device and a slave device, according to some embodiments. In some embodiments, method 1000 may be performed at a system such as system 200 discussed above with reference to FIG. 2.

At step 1010, a master device (such as master device 204) may receive from a message (such as a keycode described above) generated from an external network (such as back-end server 202). The first keycode received by the master device may include a plurality of authentication codes (such as challenge results described above) and a second keycode may include usage credits associated with one or more slave devices as described above in reference to FIG. 9. At step 1020, a controller of the master device extracts a master device challenge result from the first keycode. At step 1030, a controller of the master device determines whether the master device challenge is valid. For example, the controller of the master device may check the validity of the master device challenge result and if the master controller determines the master challenge result is valid, the master controller may retrieve a slave device challenge result from the first keycode. The master controller may also retrieve additional challenge results for other slave devices. At step 1040, the master controller transmits the retrieved slave device challenge result for requesting a communication link between the master device and the slave device in response to the determination that the master challenge result is valid. In some embodiments, requesting a communication link may include transmitting link request data (such as the challenge ID) retrieved from the first keycode and link request data (such as the public key of the master device) retrieved from the first keycode or from the master device. An example of how link request data may be used to validate the slave device challenge result is described in reference to FIGS. 3 and 4. In some embodiments, the link request may be embedded within a command sent from the server to the master device. At step 1050, a controller of the slave device determines whether to establish the communication link request based on the slave device challenge result. For example, the controller of the slave device may check the validity of the slave device challenge result and if the slave controller determines that the slave challenge result is valid and thus the server authorized the master device to communicate with the slave device, then the slave controller may establish the communication link between the slave device and the master device. If the slave controller determines that the slave device challenge result is not valid and thus the server did not authorize the master device to communicate with the slave device, then the slave controller may reject the communication link request from the master device. At step 1060, in response to the determination to establish the communication link, the slave device may take steps to establish the communication link. The communication link may be established via negotiation between the master device and the slave device using standard key negotiation protocols. At step 1070, the master controller may transmit usage credits of the second keycode to the slave device via the communication link between the master device and the slave device. In some embodiments, the master device may send all usage credits or a portion of usage credits retrieved from the second keycode to the slave device. In some embodiments, the master device may retain all usage credits for controlling the master device. In some embodiments, the master device may determine to distribute usage credits among the connected devices and itself. At step 1080, the slave controller may control the slave device based on the usage credits received from the master device. Controlling the slave device may include enabling or updating a usage status of the slave device.

In some embodiments, the master device 204 may transmit information to one or more slave devices 206 across industry standard data transport layers such as Open Connectivity Foundation (OCF) specification. For example, the master device may transmit to a slave device via OCF a message payload that includes a slave device challenge result and usage credits associated with the slave device. The slave device challenge result provides application-level security that does not rely on transport-level security. The slave device challenge result is used by the slave device to determine whether the master device is authorized by the server to send the message payload to the slave device. If the master device is authorized by the server to send the message payload to the slave device, the remaining message payload (for example, usage credits associated with the slave device) is forwarded to the slave device via a secured payload delivery channel. In this way, the application-level security contained in the message payload may establish the secured payload delivery channel even over an “insecured” data transport channel. Subsequently, the slave device may transmit messages associated with usage and/or maintenance information of the slave device to the master device via the established secured payload delivery channel. If the master device is not authorized to send the message payload to the slave device, the slave device may reject the remaining payload and notify the master device that the authorization failed.

In some embodiments, the master device may transmit usage information and application-specific commands associated with the slave device to the slave device via the established secure payload channel. Application-specific commands may include commands for turning off a burner or turning off a heater. For example, for a PAYG refrigerator or freezer, the application-specific commands received from a master device may control the minimum and maximum temperature based on the time of day. Another example includes a PAYG fan or cooling system, in which application-specific commands received from a master device may control fan speed and whether the device is on or off depending on time of day and depending on the PAYG status of the device. In some embodiments, a PAYG device such an agricultural pump may have all functions controlled via application-specific commands from the master device to minimize cost associated with operating the pump. In some embodiments, application-specific commands may adjust a functionality and performance based on the PAYG status of the device.

In some embodiments, the master device and the slave devices may communicate with each other using a combination of industry standard Constrained Application Protocol (CoAP) with payloads formatted using industry-standard Concise Binary Object Representation (CBOR). In some embodiments, devices using CoAP messaging may secure the CoAP messages through a custom packet wrapper that mathematically guarantees the integrity of the CoAP messages. The custom packet wrappers provides secured CoAP messaging for devices that do not use or does not support internet protocol communication.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. In the foregoing description of the disclosure and embodiments, reference is made to the accompanying drawings, in which are shown, by way of illustration, specific embodiments that can be practiced. It is to be understood that other embodiments and examples can be practiced, and changes can be made without departing from the scope of the present disclosure.

In addition, it is also to be understood that the singular forms “a,” “an,” and “the” used in the foregoing description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. A system for controlling electrical devices based on usage credits associated with a plurality of electrical devices, comprising:
a first controller of a first electrical device, the first controller is configured to receive a first message and a second message generated from an external network, the first message comprising a plurality of authentication codes, the second message comprising usage credits associated with a second electrical device, the first controller is further configured to extract a first authentication code of the first message, determine whether the first authentication code is valid, and in response to the determination that the first authentication code is valid, transmit a second authentication code of the first message for requesting a first communication link between the first electrical device and the second electrical device; and
a second controller of the second electrical device, the second controller is configured to determine whether to establish the first communication link based on the second authentication code of the first message, and if the communication link is established, receive a first portion of the usage credits via the established first communication link for controlling the second electrical device.

2. The system of claim 1, wherein the first controller is configured to determine a second portion of usage credits for controlling the first electrical device.

3. The system of claim 1, wherein the first controller is configured to connect to the external network for receiving the messages and the second controller is configured to be unable to connect to the external network.

4. The system of claim 1, wherein the second controller is configured to stop a function of the second electrical device if the first communication link with the first electrical device has been disrupted for a predetermined amount of time.

5. The system of claim 1, wherein the first controller is configured to transmit a third authentication code of the first message to a third controller of a third electrical device for requesting a second communication link between the first electrical device and the third electrical device, wherein the third electrical device is configured to determine whether to establish the second communication link based on the third authentication code, and if the second communication link is established, the first controller is configured to transmit a second portion of usage credits to the third controller via the established second communication link.

6. The system of claim 5, wherein the first controller is configured to determine the first portion of usage credits and the second portion of usage credits based on a priority value of the second electrical device and a priority value of the third electrical device.

7. The system of claim 1, wherein the second controller is configured to receive a third authentication code of the first message from the first controller via the first communication link, transmit the third authentication code to a third controller of a third electrical device for requesting a second communication link between the second electrical device and the third electrical device, wherein the third electrical device is configured to determine whether to establish the second communication link based on the third authentication code, and if the second communication link is established, the second controller is configured to transmit a second portion of usage credits to the third controller via the second communication link.

8. The system of claim 1, wherein the second controller is configured to update a status of usage credits associated with second electrical device in accordance with the transmitted first portion of usage credits, monitor usage of the second electrical device, and track remaining usage credits based on the status of usage credits and the monitored usage.

9. A method for controlling electrical devices based on usage credits associated with a plurality of electrical devices, comprising:
receiving, by a first controller of a first electrical device, a first message and a second message generated from an external network, the first message comprising a plurality of authentication codes, the second message comprising usage credits associated with a second electrical device;
extracting, by a first controller, a first authentication code of the first message;
determining, by the first controller, whether the first authentication code is valid;
transmitting, from the first controller, a second authentication code of the first message to a second controller of the second electrical device for requesting a first communication link between the first electrical device and the second electrical device in response to the determination that the first authentication code is valid;
determining, by the second controller, whether to establish the first communication link based on the second authentication code of the message;
establishing the first communication link in response to the determination to establish the first communication link;
transmitting, by the first controller, a first portion of usage credits to the second controller via the established first communication link; and
controlling, by the second controller, the second electrical device based on the transmitted first portion of usage credits.

10. The method of claim 9 comprising determining, by the first controller, a second portion of the usage credits for controlling the first electrical device.

11. The method of claim 9 comprising connecting the first controller to the external network for receiving the messages.

12. The method of claim 9 comprising transmitting, by the first controller, a third authentication code of the first message to a third electrical device for requesting a second communication link between the first electrical device and the third electrical device, determining whether to establish the second communication link, and transmitting a second portion of usage credits to the third controller via the established second communication link.

13. The method of claim 12 comprising determining, by the first controller, the first portion of usage credits and the second portion of usage credits based on a priority value of the second electrical device and a priority value of the third electrical device.

14. The method of claim 9 comprising updating a status of usage credits associated with the second electrical device in accordance with the transmitted first portion of usage credits, monitoring usage of the second electrical device, and tracking remaining usage credits based on the status of usage credits and the monitored usage by the second controller.

15. A system for controlling devices based on usage credits associated with a plurality of electrical devices, comprising:
one or more processors;
memory;
one or more programs, wherein the one or more programs are stored in the memory and configured to be executed by the one or more processors, the programs including instructions for:
receiving a first identification information associated with the first electrical device, a second identification information associated with the second electrical device, and usage information associated with the second electrical device;
generating a first message comprising a plurality of authentication codes and a second message comprising usage credits based on the first identification, the second identification, and the usage information;
transmitting the first message for retrieval at a first controller of the first electrical device for allowing the first controller to establish a first authorized link between the first electrical device and the system based on a first authentication code of the message and for allowing the second controller to establish a second authorized link between the first electrical device and the second electrical device based on a second authentication code of the message; and
transmitting the second message for retrieval at the first controller for allowing the first controller to control the second electrical device based on usage credits.

16. The system of claim 15, wherein the programs include instructions for determining which electrical devices are permitted to link based on the received identification information and generating corresponding authentication codes for each permitted link.

17. The system of claim 15, wherein generating the first authentication code for the first electrical device comprises using a first secret information only known to the system and the first electrical device and generating the second authentication code for the second electrical device comprises using a second secret information only known to the system and the second electrical device.

18. The system of claim 15, wherein the system is a remote server.

19. A method for controlling devices based on usage credits associated with a plurality of electrical devices, comprising:
receiving, at a remote server, a first identification information associated with the first electrical device, a second identification information associated with the second electrical device, and usage information associated with the second electrical device;
generating by the remote server a first message comprising a plurality of authentication codes and a second message comprising usage credits based on the first identification, the second identification, and the usage information;
transmitting the first message for retrieval at a first controller of the first electrical device for allowing the first controller to establish a first authorized link between the first electrical device and the remote server based on a first authentication code of the message and for allowing the second controller to establish a second authorized link between the first electrical device and the second electrical device based on a second authentication code of the message; and
transmitting the second message for retrieval at the first controller for allowing the first controller to control the second electrical device based on usage credits.

20. The method of claim 19 comprising determining which electrical devices are permitted to link based on the received identification information and generating corresponding authentication codes for each permitted link.
